(19) United States
(12) Patent Application Publication
(10) Pub. No.: US 2022/0252089 A1
(43) Pub. Date: Aug. 11, 2022

(54) ROTARY ACTUATOR

(71) Applicant: QUALITY MANUFACTURING INC., Winchester, KY (US)

(72) Inventors: Harold Howard, Winchester, KY (US); George Evan Mattingly, Winchester, KY (US); Jeffrey John Sweda, Lexington, KY (US); Jeffrey A. Rose, Lexington, KY (US)

(21) Appl. No.: 17/648,359

(22) Filed: Jan. 19, 2022

Related U.S. Application Data
(60) Provisional application No. 63/139,687, filed on Jan. 20, 2021.

(51) Int. Cl. F15B 15/12

(52) U.S. Cl. CPC F15B 15/125

(57) ABSTRACT

Devices and systems for producing rotational actuation are described. Hydraulic and pneumatic actuators can produce and control rotational motion. A rotary joint may be configured to allow parallel coupling of multiple actuators, and thus increase the range of rotation of the actuators when considered collectively. The actuators may include pistons and piston rods having torus shapes. Methods of manufacturing rotary joints are also described.

### RELATED CASES

This application claims priority to U.S. Provisional Application No. 63/139,687 filed on Jan. 20, 2021, titled “HYDRAULIC ROTARY ACTUATOR,” which is hereby incorporated by reference in its entirety.

### STATEMENT REGARDING FEDERALLY SPONSORED RESEARCH OR DEVELOPMENT

This invention was made with government support under Contract W911NF-21-P-0015 awarded by Army Futures Command of the United States Army. The government has certain rights in the invention.

### TECHNICAL FIELD

Devices and systems for producing rotational actuation are described. More specifically, hydraulic and pneumatic actuators that can produce and control rotational or joint-like motion are described. An actuator may be configured to allow parallel coupling of multiple actuators, and thus increase the range of rotation of the actuators when considered collectively.

### BRIEF DESCRIPTION OF THE DRAWINGS

The embodiments disclosed herein will become more fully apparent from the following description and appended claims, taken in conjunction with the accompanying drawings. These drawings depict only typical embodiments, which will be described with additional specificity and detail through use of the accompanying drawings in which:

FIG. 1 is a perspective view of an embodiment of a single torus piston rod.

FIG. 2A is a perspective view of an embodiment of a piston for press fit into a piston rod gap.

FIG. 2B is a side view of the embodiment of a piston of FIG. 2A, with dashed lines representing hidden surfaces of extrusions in the piston.

FIG. 2C is a perspective view of another embodiment of a piston. More specifically, the embodiment shown in FIG. 2C is a piston half for coupling to a piston rod.

FIG. 3 is a cut away view of an embodiment of a piston rod and axle linkage mechanism tongue and groove.

FIG. 4 is a perspective view of an embodiment of a piston, rod, linkage, and axle assembly.

FIG. 5 is a perspective view of a portion of an embodiment of a dual rotary actuator with notched piston rods, with one housing shown and another housing omitted to show a cylinder.

FIG. 6 is a perspective view of an embodiment of a dual rotary actuator, including piston rods, linkages, and an axle assembly.

FIG. 7 is a perspective view of an embodiment of a tactile sensor electrode.

FIG. 8 is a perspective view of the tactile sensor electrode of FIG. 7 with a silicone covering.

FIG. 9 is a layout of an embodiment of a contact pressure detection hydraulic circuit.

### DETAILED DESCRIPTION

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in the drawings, the drawings are not necessarily drawn to scale unless specifically indicated.

The phrase “coupled to” is broad enough to refer to any suitable coupling or other form of interaction between two or more entities, including mechanical and fluidic interaction. Thus, two components may be coupled to each other even though they are not in direct contact with each other. The phrase “fluid communication” is used in its ordinary sense, and is broad enough to refer to arrangements in which a fluid (e.g., a gas or a liquid) can flow from one element to another element when the elements are in fluid communication with each other.

References to approximations are made throughout this specification, such as by use of the term “substantially.” For each such reference, it is to be understood that, in some embodiments, the value, feature, or characteristic may be specified without approximation. For example, where qualifiers such as “about” and “substantially” are used, these terms include within their scope the qualified words in the absence of their qualifiers. For example, where the term “substantially perpendicular” is recited with respect to a feature, it is understood that in some embodiments the feature may have a precisely perpendicular configuration.

Embodiments of hydraulic and pneumatic rotary actuators similar to the rotary actuators disclosed in U.S. Pat. No. 10,718,359 are presented herein. The disclosure of U.S. Pat. No. 10,718,359 is incorporated by reference herein in its entirety. Embodiments of a dual directional actuator with at least one piston and piston rod are illustrated and described.

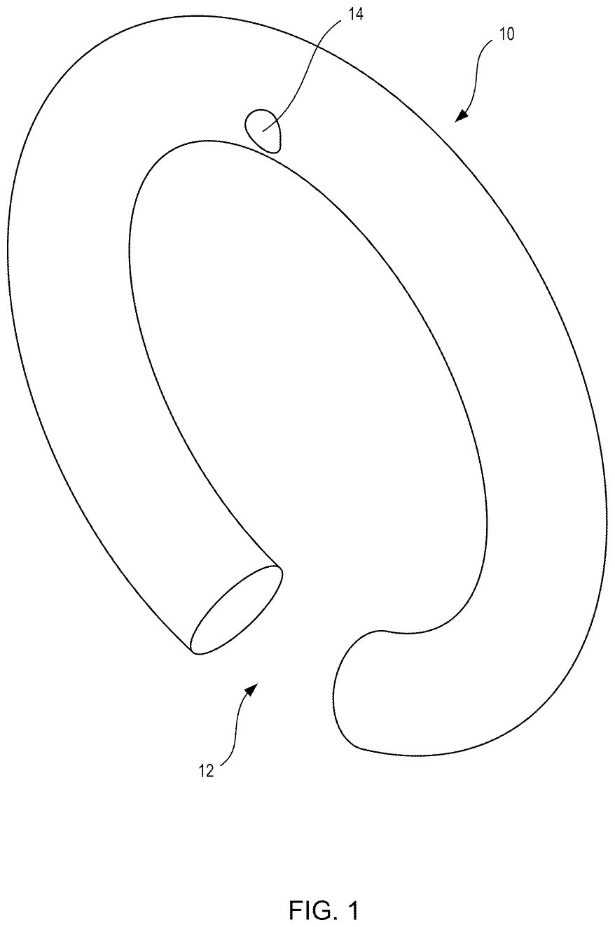

In some embodiments, a piston and piston rod assembly include a gap opening in the piston rod. FIG. 1 illustrates an embodiment of a single torus piston rod 10. The piston rod 10 may include a solid continuous piston rod element with a torus shape and a gap opening 12. The piston rod 10 may have a mating feature 14. The gap opening 12 may be used to couple a piston to the piston rod 10, for example, by pressing or forming the piston onto the piston rod 10. The mating feature 14 may be a hole, as illustrated in FIG. 1. The hole may be used to couple the piston rod 10 to a drive mechanism, for example, by inserting the drive mechanism through the hole. The gap opening 12 in the piston rod 10 may also be used to facilitate insertion of the piston rod 10 into a single torus cylinder. The piston rod 10 may be inserted into the cylinder and a piston may be coupled to the piston rod 10. As described further below, end caps for a cylinder housing may be placed on the piston rod 10 prior to insertion into the torus cylinder.

In some embodiments, the piston rod may have a noncircular cross section. The piston rod may nonetheless have a toroid shape, and operate in a similar fashion to the piston rod 10.

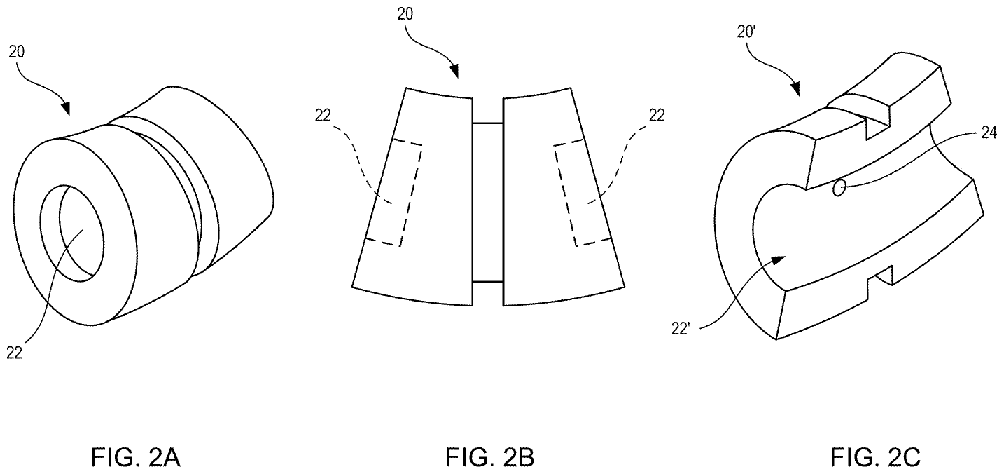

A piston 20 is illustrated in FIGS. 2A and 2B. The piston 20 may have a torus shape. For example, the piston 20 may have a circular cross section and may have a width dimension with a profile that follows an arcuate path. The piston 20 may have extrusions 22, into each of which an end of the piston rod 10 may be inserted. For example, an extrusion 22 may be disposed on each side of the width of the piston 20. The ends of the piston rod 10 may be inserted into the extrusions 22 to couple the piston 20 to the piston rod 10. The extrusions 22 may each have a diameter approximately equal to a minor diameter (thickness) of the piston rod 10. This may help to form a tight fit between the piston 20 and piston rod 10, thereby helping to prevent the ends of the piston rod 10 from inadvertently slipping out of the extrusions 22 of the piston 20.

In some embodiments, after the piston rod 10 is inserted into the torus cylinder, the piston 20 may be pressed into the gap opening 12 of the piston rod 10. The width of the gap opening 12 (when the piston rod 10 is in a relaxed state) may be smaller than a width of the piston 20, such that the coupling of the piston 20 to the piston rod 10 forms a tight fit. The tight fit may help to ensure that the ends of the piston rod 10 do not inadvertently slip out of the extrusions 22 of the piston 20. Together, the piston 20 and piston rod 10 may create an uninterrupted or continuous torus piston and piston rod assembly.

FIG. 2C depicts an embodiment of a piston half 20′ that resembles the piston 20 described above in certain respects. Accordingly, like features are designated with like reference numerals, with a prime symbol appended onto the reference numeral. For example, the embodiment depicted in FIG. 2C includes an extrusion 22′ that may, in some respects, resemble the extrusion 22 of FIGS. 2A-2B. Relevant disclosure set forth above regarding similarly identified features thus might not be repeated hereafter. Moreover, specific features of a piston and a piston rod and related components shown in FIGS. 1-2B might not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the piston half 20′ and related components depicted in FIG. 2C. Any suitable combination of the features, and variations of the same, described with respect to the piston 20 and related components illustrated in FIGS. 2A-2B can be employed with the piston half 20′ and related components of FIG. 2C, and vice versa. This pattern of disclosure applies equally to further embodiments depicted in subsequent figures and described hereafter, wherein the reference numerals may be further appended, such as with a double prime symbol.

The alternative embodiment shown in FIG. 2C allows for coupling two piston halves 20′ to a piston rod 10. The piston half 20′ may have an extrusion 22′ that fits over the torus shape of the piston rod 10. Each piston half 20′ may be coupled to the piston rod 10 at the position of the hole (mating feature 14) in the piston rod 10 of FIG. 1. The piston half 20′ may include a corresponding hole 24 for coupling the piston half 20′ to the piston rod 10. Then, the piston halves 20′ may be overmolded onto the piston rod and the gap opening 12 in the piston rod 10 may be used to drive an axle-rod linkage drive mechanism as explained in U.S. Pat. No. 10,718,359.

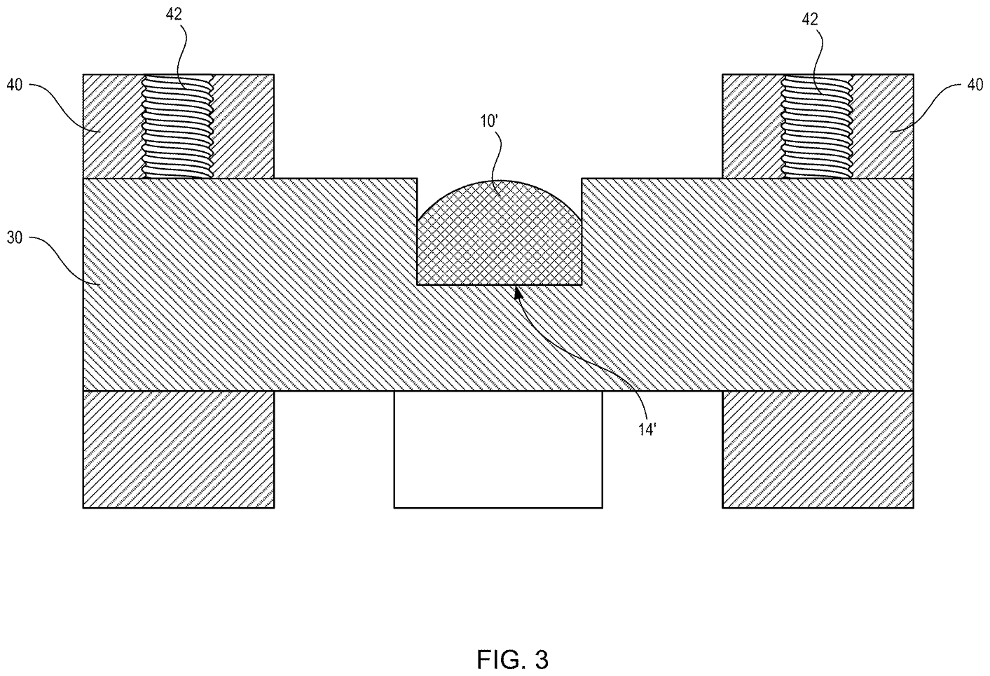

FIG. 3 depicts a tongue and groove embodiment for an axle-rod linkage drive mechanism. As shown, a piston rod 10′ may be coupled with a drive mechanism 30 and linkages 40. The piston rod 10′ may have an alternative mating feature 14′. The mating feature 14′ may be a notch (for example, instead of a hole), to couple the piston rod 10′ to the drive mechanism 30. The drive mechanism 30 may be a drive pin. In alternative embodiments, the hole (mating feature 14) shown in FIG. 1 in the piston rod 10 may be used to couple the piston rod 10 to the drive mechanism 30, and consequently to the linkages 40.

The linkages 40 may have threaded holes 42, through which screws or bolts may be inserted to couple the linkages 40 to the drive mechanism 30. The linkages 40 may be cranks, arms, or other mechanisms for passing torque from the piston rods 10′ to an axle assembly.

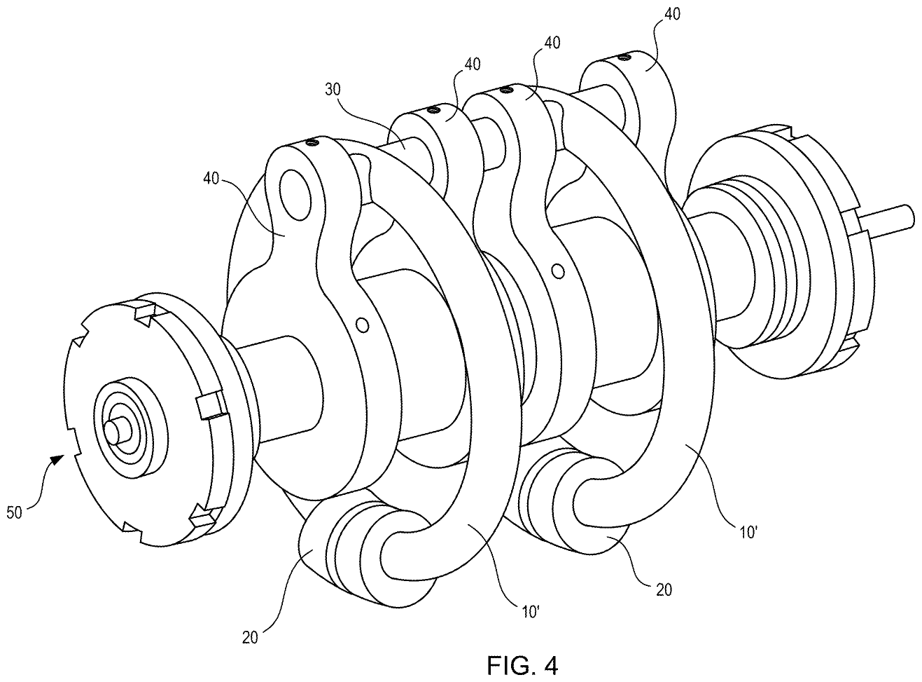

FIG. 4 illustrates an embodiment of an assembly of pistons 20, piston rods 10′, a drive mechanism 30, linkages 40, and an axle assembly 50 using the tongue and groove embodiment of FIG. 3. The piston rod and axle linkage tongue and groove embodiment is configured to strengthen the components for high forces that may be applied. In some embodiments, after insertion of the piston 20 and piston rod 10′ into a torus cylinder, and after coupling the piston rod 10′ to the drive mechanism 30, an intersection of the piston rod 10′ and the drive mechanism 30 may be overmolded with a nylon or PEEK plastic to secure the drive mechanism 30 to the mating feature 14′ of the piston rod 10′, and at the same time provide a higher strength junction than may exist without the overmolding.

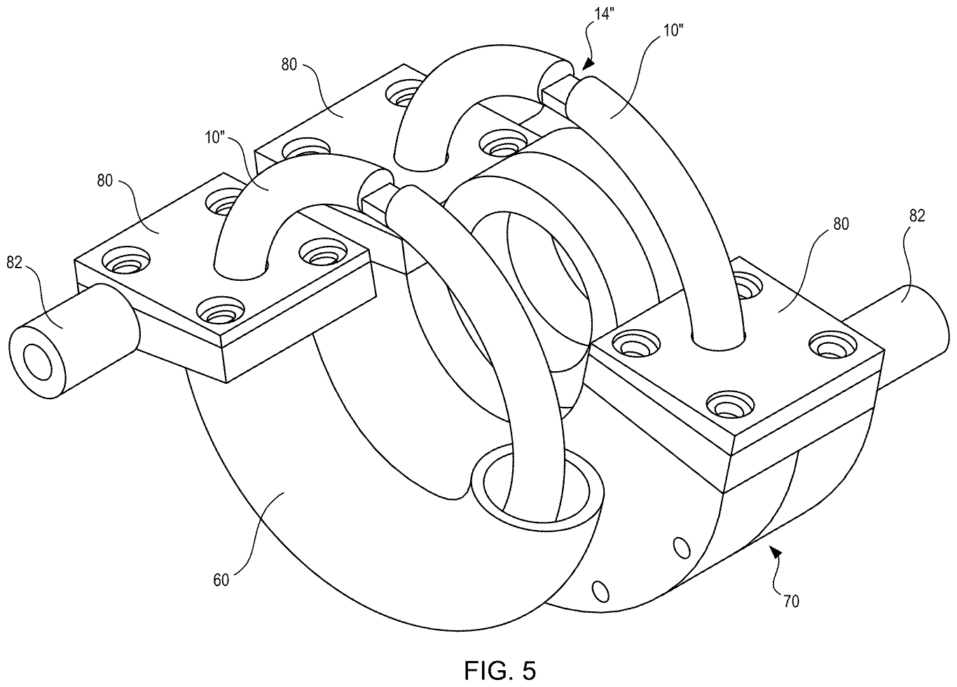

FIG. 5 illustrates a portion of a dual actuator assembly of an embodiment of the hydraulic rotary actuator. As illustrated, two piston rods 10″ with corresponding assemblies may be used in the rotary actuator. The piston rods 10″ may have mating features 14″. The mating features 14″ may be notches. While the mating feature 14′ depicted in FIGS. 3 and 4 is a notch on an underside of the piston rod 10′ (on the inside of the piston rod's torus shape), the mating features 14″ depicted in FIG. 5 are notches on a topside of the piston rods 10″ (on the outside of the piston rod's torus shape). The notches may be used for coupling a drive mechanism to the piston rods 10″.

FIG. 5 also depicts a cylinder 60, which may be included in the dual actuator assembly of the rotary actuator. The cylinder 60 may have a torus shape. In some embodiments, the piston rod 10″ may be partially disposed within the cylinder 60. A piston coupled to the piston rod 10″ may be at least partially disposed within the cylinder 60. In the view of FIG. 5, a housing for the cylinder is omitted on one of the sides of the dual actuator assembly, while another housing 70 is depicted on the other side. End caps 80 may be coupled to the cylinder 60 and/or the housing 70. The end caps 80 may seal a chamber for fluidic actuation (whether hydraulic actuation or pneumatic actuation) of the pistons within the chamber. Thus, the rotary actuator may be actuatable by fluid pressure.

In some embodiments, the cylinders 60 may be omitted, in which case the housings 70 may form the chambers. In some embodiments, the housings 70 may be omitted, in which case the chambers are formed within the cylinders 60. In some embodiments, a housing 70 may be overmolded onto a cylinder 60, or otherwise coupled to the cylinder 60, to give structure for coupling the cylinder 60 to the rest of the rotary actuator assembly. The overmolding may use a high strength plastic such as nylon to increase the pressure rating of the cylinder 60. Structures to bolt the end caps 80 and actuator housing may be molded onto the cylinder 60.

The end caps 80 may each include a port 82. The port 82 may be in fluid communication with the cylinder 60 or the chamber. Thus, the port 82 may be used for filling the cylinder 60 or the chamber with fluid and/or withdrawing the fluid from the cylinder 60 or chamber. The fluid may be a liquid (for hydraulic actuation) or a gas (for pneumatic actuation).

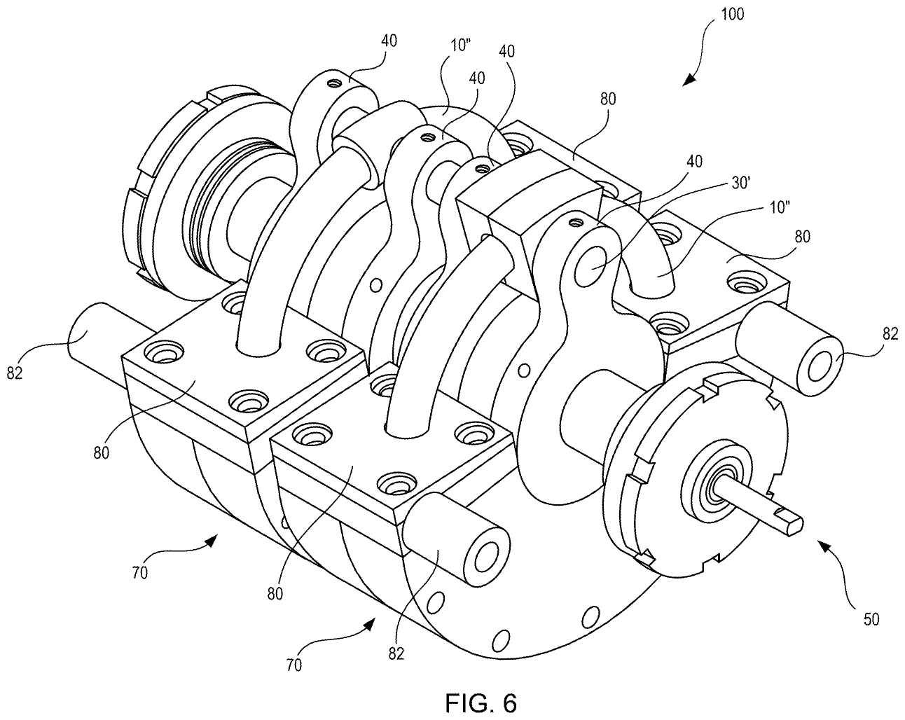

FIG. 6 depicts a full assembly 100 of an embodiment of a rotary actuator. As depicted, a housing 70 may encapsulate each cylinder. The axle assembly 50 may transfer power from the linkages 40 (generated by the pistons and first transferred by the piston rods 10″ to the drive mechanism 30′) to a receiving portion of a rotary joint. The opposite direction of power transfer may also be possible, i.e., from the axle assembly 50 to the linkages 40, to the drive mechanism 30′, and then to the piston rods 10″ and pistons.

In some embodiments of the rotary actuator, more than two assemblies of a piston and piston rod may be used. For example, in some embodiments, the rotary actuator may have three piston and piston rod assemblies. In some embodiments, the rotary actuator may have four piston and piston rod assemblies.

Methods of assembling the rotary actuator may include inserting a torus-shaped piston rod into a torus-shaped cylinder. In some embodiments, the insertion of the piston rod into the cylinder may be done before coupling a piston to the piston rod. The piston may be coupled to the piston rod at a gap opening of the piston rod. The piston may be rotated into the cylinder. This may be done before coupling the piston to the piston rod, though in preferred embodiments it is done after coupling the piston to the piston rod. End caps may be coupled to the piston rod before coupling the piston to the piston rod. After rotating the piston into the cylinder, the end caps may be coupled to the cylinder and/or a housing of the cylinder. Coupling of the end caps to the cylinder and/or the housing may be done by welding and/or mechanical fastening, such as using screws or bolts.

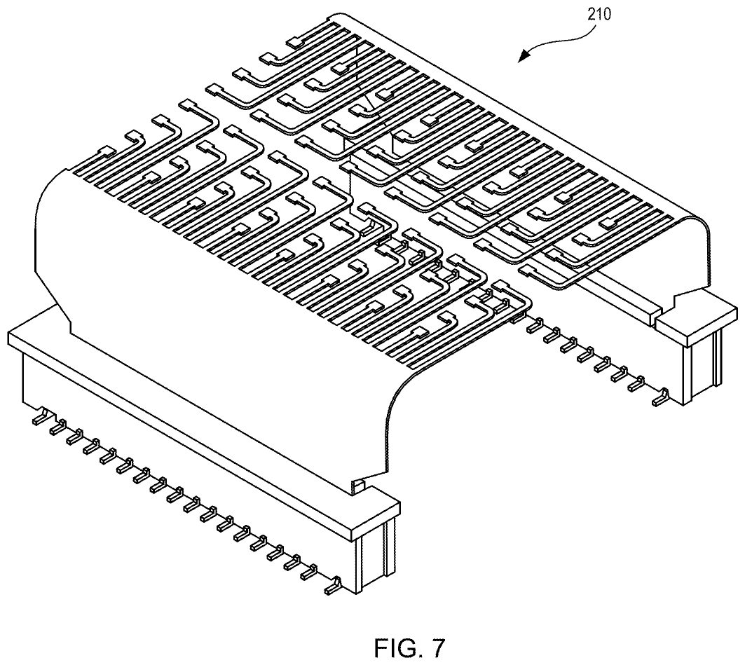

FIG. 7 illustrates a layout for a flexible tactile sensor 210. This layout illustrates an arrangement where electrodes are arranged to cover an area of a contact surface between a robotic hand and an object grasped. The electrodes are arranged so that they do not overlap and are kept in a straight alignment. The electrodes are attached to a common plug for analog measurements. The electrodes may be manufactured of a Flexible Printed Circuit material.

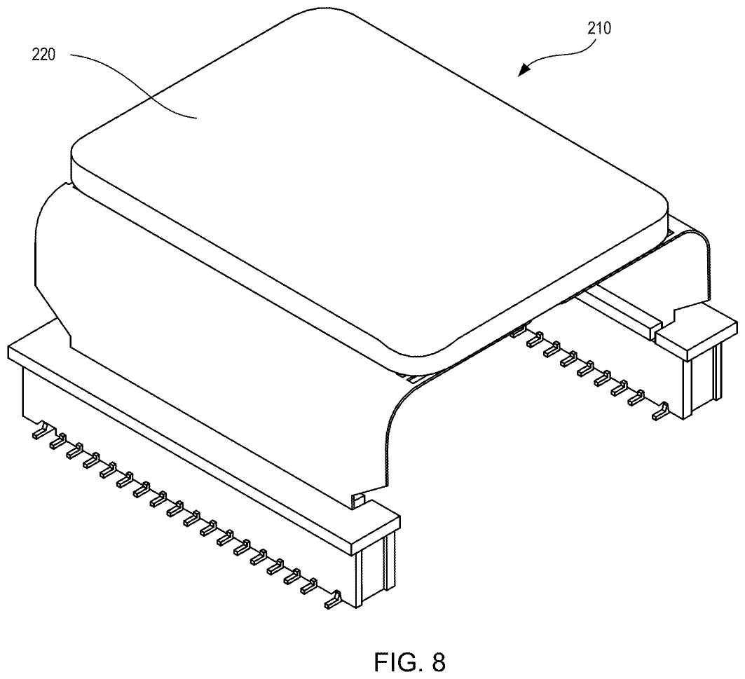

The electrodes of FIG. 7 can be sealed with a flexible material 220, such as silicone, as illustrated in FIG. 8.

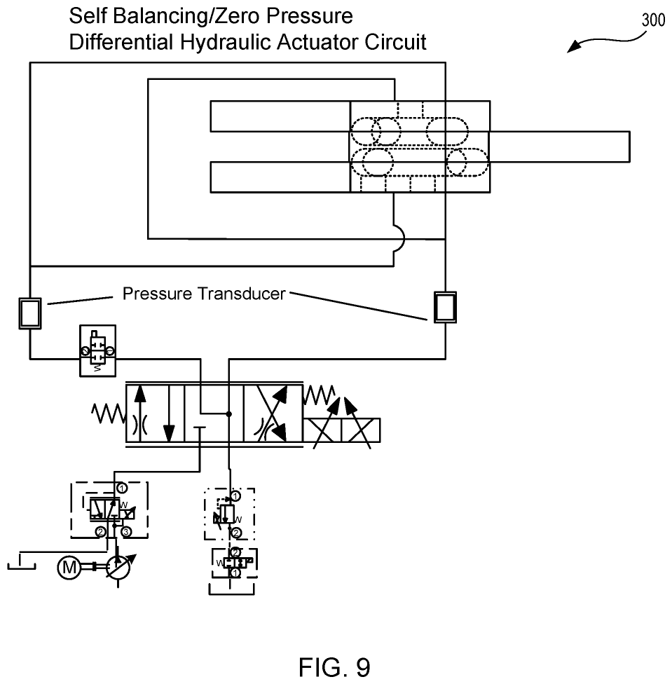

Another aspect of the present disclosure is related to collaborative robot operation. In certain instances, a collaborative robot will use a force/torque sensor to determine when the robot has made contact with an object. In some embodiments, a fluid pressure increase from a contact force made by a robotic arm is used to prevent injury to a person nearby the robot. A pressure sensor, such as Honeywell's Industrial Pressure Sensors MLH Series, 13 mm Series, or SPT Series, can measure changes in the fluid pressure of a hydraulic rotary actuator. The pressure change is measured to a high degree of sensitivity, and pressure due to gravity, acceleration, velocity, and payload may be considered to determine the pressure change due to collision or contact between the robot and the person. An embodiment disclosed herein uses changes in fluid pressure instead of torque or force to measure the force of collision. The fluid pressure may experience a rapid rise when contact between robotic arms or joints is encountered. The pressure spike may be of a short duration so the pressure sensor has a high sampling rate to determine the momentary rise of pressure due to contact. A hydraulic circuit 300 used to perform this high rate of sampling is illustrated in FIG. 9.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

We claim:

1. A rotary actuator, comprising:
a piston; and
a piston rod comprising:
a torus shape; and
a gap opening disposed in the torus shape;
wherein the piston is coupled to the piston rod at the gap opening.

2. The rotary actuator of claim 1, wherein a width of the gap opening when the piston rod is in a relaxed state is smaller than a width of the piston, such that the coupling of the piston to the piston rod forms a tight fit.

3. The rotary actuator of claim 1, wherein the piston comprises an extrusion configured to receive an end of the piston rod.

4. The rotary actuator of claim 1, wherein the piston rod comprises a mating feature configured to couple with a drive mechanism.

5. The rotary actuator of claim 4, wherein the mating feature is a notch.

6. The rotary actuator of claim 4, wherein the mating feature is a hole.

7. The rotary actuator of claim 1, further comprising a drive mechanism coupled to the piston rod.

8. The rotary actuator of claim 7, further comprising an axle and at least one linkage, wherein the at least one linkage is coupled to the drive mechanism adjacent a first end of the at least one linkage, and wherein the at least one linkage is coupled to the axle adjacent a second end of the at least one linkage, such that the rotary actuator comprises a fixed connection between the piston rod and the axle.

9. An assembly for a rotary joint, the assembly comprising:
a cylinder having a torus shape;
a piston rod having a torus shape, the piston rod being partially disposed within the cylinder; and
a piston,
wherein a first end of the piston rod is coupled to a first side of the piston, a second end of the piston rod is coupled to a second side of the piston, and the piston is at least partially disposed within the cylinder.

10. The assembly of claim 9, wherein the piston comprises a first extrusion in the first side, and a second extrusion in the second side, and wherein the first end of the piston rod is inserted into the first extrusion of the piston and the second end of the piston rod is inserted into the second extrusion of the piston.

11. The assembly of claim 10, wherein the first extrusion and the second extrusion each comprise a diameter approximately equal to a minor diameter of the piston rod.

12. The assembly of claim 10, wherein the piston is configured to fit onto the piston rod such that the ends of the piston rod do not inadvertently slip out of the extrusions of the piston.

13. The assembly of claim 9, further comprising a drive mechanism forming a connection to an axle of the rotary joint.

14. The assembly of claim 9, wherein the rotary joint is actuatable by fluid pressure.

15. A method of manufacturing a rotary actuator, the method comprising:
first, inserting a torus-shaped piston rod into a torus-shaped cylinder; and
second, coupling a piston to the torus-shaped piston rod at a gap opening of the torus-shaped piston rod.

16. The method of claim 15, further comprising rotating the piston into the torus-shaped cylinder.

17. The method of claim 15, further comprising coupling a first end cap onto a first side of the torus-shaped piston rod and a second end cap onto a second side of the torus-shaped piston rod, the coupling of the first and second end caps onto the torus-shaped piston rod occurring before the coupling of the piston to the torus-shaped piston rod.

18. The method of claim 17, further comprising coupling the first end cap to a first side of the torus-shaped cylinder, and coupling the second end cap to a second side of the torus-shaped cylinder.

19. The method of claim 18, wherein the coupling of the first end cap to the first side of the torus-shaped cylinder comprises welding the first end cap to a housing of the torus-shaped cylinder.

20. The method of claim 18, wherein the coupling of the first end cap to the first side of the torus-shaped cylinder comprises connecting the first end cap to a housing of the torus-shaped cylinder using one or more mechanical fasteners.
